(19) United States
(12) Patent Application Publication
(10) Pub. No.: US 2012/0022179 A1
(43) Pub. Date: Jan. 26, 2012

(54) PROCESS FOR PRODUCING RIGID POLYURETHANE FOAMS

(75) Inventors: Andreas Emge, Shanghai (CN); Marc Fricke, Osnabrueck (DE); Roman Prochazka, Mannheim (DE); Holger Seifert, Bohmte (DE); Darijo Mijolovic, Mannheim (DE); Achim Loeffler, Speyer (DE); Sirus Zarbakhsh, Hongkong (CN)

(73) Assignee: BASF SE, LUDWIGSHAFEN (DE)

(21) Appl. No.: 13/143,144

(22) PCT Filed: Jan. 12, 2010
(86) PCT No.: PCT/EP10/50299

§ 371 Date: Jul. 1, 2011

(30) Foreign Application Priority Data
Jan. 20, 2009 (EP) 09150896.0

(51) Int. Cl. C08J 9/228; C08G 18/32

(52) U.S. Cl. 521/174

(57) ABSTRACT

The invention relates to a process for producing rigid polyurethane foams by reacting
a) polyisocyanates with
b) compounds having at least two hydrogen atoms which are reactive toward isocyanate groups in the presence of
c) blowing agents,
   wherein the component b) comprises at least one polyether alcohol bi) prepared by addition of alkylene oxides onto toluenediamine and at least one polyether alcohol bii) prepared by addition of alkylene oxides onto H-functional starter substances comprising oligomeric glycerol.

The invention relates to a process for producing rigid polyurethane (hereinafter referred to as PU for short) foams.

The production of rigid PU foams is known and has been described many times.

They are used, in particular, for producing composite or sandwich elements which are made up of a rigid PU foam and at least one covering layer of a rigid or elastic material such as paper, plastic films, aluminum foil, metal sheets, glass nonwovens or chipboard. Filling hollow spaces in household appliances such as refrigeration appliances, for example upright or chest refrigerators or hot water storages, with rigid PU foam as thermal insulation material is also known. Further applications are insulated pipes comprising an inner pipe of metal or plastic, a polyurethane insulation layer and an outer sheath of polyethylene. The insulation of large storage vessels or transport ships, for example for the storage and transport of liquids or liquefied gases in the temperature range from 160° C. to −160° C., is also possible.

Heat- and cold-insulating rigid PU foams which are suitable for this purpose can, as is known, be produced by reaction of organic polyisocyanates with one or more compounds having at least two groups which are reactive toward isocyanate groups, preferably polyester polyols and/or polyether polyols, and usually with concomitant use of chain extenders and/or crosslinkers in the presence of blowing agents, catalysts and optionally auxiliaries and/or additives. With suitable choice of the formative components, rigid PU foams having a low thermal conductivity and good mechanical properties can be obtained in this way.

A summary overview of the production of rigid PU foams and their use as covering or preferably core layer in composite elements and also their use as insulation layer in refrigeration or heating engineering has been published, for example, in Polyurethane, Kunststoff-Handbuch, volume 7, 3rd edition 1993, edited by Dr. Günter Oertel, Carl Hanser Verlag, Munich, Vienna.

An ongoing objective in the production of rigid polyurethane foams is to achieve a reduction in the thermal conductivity without the mechanical and processing properties being adversely affected.

One possible way of reducing the thermal conductivity is to increase the content of aromatic components in the polyol, as described in EP 708127. However, this possibility is limited by the viscosity of the polyol component and the crosslinking of the foam.

Recently, rigid polyurethane foams produced using polyether alcohols based on toluenediamine (TDA) have gained in importance. Such polyols have a low viscosity and lead to a reduction in the thermal conductivity of the foams. However, since these polyols have a functionality of only four, additional use has to be made of polyether alcohols having a higher functionality in order to achieve sufficient crosslinking of the foams. These are usually polyols based on sugar, in particular sucrose. However, these increase the viscosity of the polyol component and decrease the flowability of the polyurethane systems.

It was therefore an object of the present invention to provide rigid polyurethane foams which have a low thermal conductivity using polyether alcohols based on TDA. The polyol component should have a low viscosity and the flowability of the polyurethane system should be high. Furthermore, the foam should have high crosslinking.

The crosslinking density can be calculated from the raw materials used. The principle is to calculate the molecular mass of the groups which are located between 2 nodes. This is described, for example, in J. H. Saunders, K. C. Frisch “Polyurethanes, Vol 1, Chemistry”, 1962, Interscience Wiley, New York, pp. 264-267.

This object has surprisingly been able to be achieved by concomitant use of a polyether alcohol which has been prepared by addition of alkylene oxides onto oligomeric glycerol in the polyol component.

The invention accordingly provides a process for producing rigid polyurethane foams by reacting
a) polyisocyanates with
b) compounds having at least two hydrogen atoms which are reactive toward isocyanate groups in the presence of
c) blowing agents,
   wherein the component b) comprises at least one polyether alcohol bi) prepared by addition of alkylene oxides onto toluenediamine and at least one polyether alcohol bii) prepared by addition of alkylene oxides onto H-functional starter substances comprising oligomeric glycerol.

The oligomeric glycerol is preferably made up of 4-10 glycerol units.

The polyether alcohol bii) preferably has a hydroxyl number in the range from 350 to 500 mg KOH/g. It is produced by the base-catalyzed addition of alkylene oxides, preferably ethylene oxide and/or propylene oxide, particularly preferably pure propylene oxide onto the oligomeric glycerol as described below.

In an embodiment of the invention, the starter substance in the preparation of the polyether alcohol bii) comprises exclusively oligomeric glycerol.

In a further embodiment of the invention, the starter substance in the preparation of the polyether alcohol bii) comprises oligomeric glycerol and at least one further H-functional compound. The further compounds can be alcohols or amines. Preference is given to using alcohols having at least 3 hydroxyl groups as further H-functional compound.

In an embodiment of the invention, the starter substance in the preparation of the polyether alcohol bii) comprises oligomeric glycerol and trimethylolpropane. In a further embodiment of the invention, the starter substance in the preparation of the polyether alcohol bii) comprises oligomeric glycerol and at least sucrose or sorbitol.

Here, the polyether alcohol bii) preferably has a molar ratio of oligomeric glycerol to sucrose or sorbitol of from 2.5:1 to 1:2.5.

In the preparation of the polyether alcohol bi), it is in principle possible to use all isomers of TDA. It is possible to use a mixture which does not comprise any o-TDA. Preference is given to mixtures which comprise at least 25% by weight, based on the weight of the TDA, of o-TDA, also referred to as vicinal TDA. In a particularly preferred embodiment of the invention, the mixtures of TDA isomers comprise at least 95% by weight, based on the weight of the TDA, of vicinal TDA. The polyether alcohols are prepared by addition of ethylene oxide, propylene oxide and mixtures thereof onto TDA. When ethylene oxide and propylene oxide are used, the alkylene oxides can be added on either individually in succession or in a mixture with one another. In one embodiment, ethylene oxide is added on first and propylene oxide is then added on. The addition reaction of the ethylene oxide is preferably carried out in the absence of a catalyst and the addition reaction of the propylene oxide is carried out in the presence of a basic catalyst.

The polyether alcohol bi) preferably has a hydroxyl number in the range from 120 to 450.

In a preferred embodiment of the invention, the components bi) and bii) are used in a weight ratio of from 5:1 to 1:2.

The component b) can comprise not only the components bi) and bii) but also further compounds having at least two hydrogen atoms which are reactive toward isocyanate groups.

In a preferred embodiment of the invention, the component b) comprises a polyether alcohol biii) initiated using at least sucrose in addition to the components bi) and bii). The polyether alcohol biii) preferably has a hydroxyl number in the range from 350 to 550.

In a particularly preferred embodiment of the invention, the polyether alcohols bii) and biii) are used in a weight ratio of from 1:10 to 2:1.

Oligomeric glycerol, also referred to as polyglycerol, is known. Polyglycerol is formed by base-catalyzed reaction with itself. The oligomerization of glycerol can also be carried out in the presence of other polyfunctional alcohols, for example pentaerythritol or trimethylolpropane. Here, the glycerol is present in a molar excess since otherwise excessively highly viscous or solid products are formed. In particular, the molar ratio of glycerol to the other alcohol is from 5:1 to 10:1, in particular 9:1. An advantage of the concomitant use of other alcohols, in particular trimethylolpropane, is the better compatibility with the other starting components for the polyurethane system, in particular with the hydrocarbons which are preferably used as blowing agent. The alkoxylation of oligomeric glycerol is preferably carried out in the presence of alkaline catalysts. Particular preference is given to potassium hydroxide or tertiary amines.

The use of polyether alcohols prepared by reaction of polyglycerol with alkylene oxides as starting component for rigid polyurethane foams is known in principle. Thus, a poster “Polyether Polyols Based On Polyglycerol” by Ionescu et al. at the Polyurethanes Technical Conference on Sep. 24-26, 2007 in Orlando described polyglycerol-initiated polyether alcohols and a rigid polyurethane foam produced using these polyols. Advantages mentioned for the polyglycerol-initiated polyether alcohols were, in particular, the low viscosity of the polyglycerol and the comparatively high functionality of the polyols. The polyglycerol-initiated polyether alcohol was used in combination with a sucrose-initiated polyether alcohol.

As regards the starting compounds which can be used in addition to the above-described polyether alcohols in the process of the invention, the following details may be provided.

Possible organic polyisocyanates a) are all known organic diisocyanates and polyisocyanates, preferably aromatic polyfunctional isocyanates.

Specific mention may be made by way of example of tolylene 2,4- and 2,6-diisocyanate (TDI) and the corresponding isomer mixtures, diphenylmethane 4,4′-, 2,4′- and 2,2′-diisocyanate (MDI) and the corresponding isomer mixtures, mixtures of diphenylmethane 4,4′- and 2,4′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates. The organic diisocyanates and polyisocyanates can be used individually or in the form of mixtures.

Use is frequently also made of modified polyfunctional isocyanates, i.e. products obtained by chemical reaction of organic diisocyanates and/or polyisocyanates. Examples which may be mentioned are diisocyanates and/or polyisocyanates comprising uretdione, carbamate, isocyanurate, carbodiimide, allophanate and/or urethane groups. The modified polyisocyanates can, if appropriate, be mixed with one another or with unmodified organic polyisocyanates such as diphenylmethane 2,4′-, 4,4′-diisocyanate, crude MDI, tolylene 2,4- and/or 2,6-diisocyanate.

In addition, it is also possible to use reaction products of polyfunctional isocyanates with polyhydric polyols and also mixtures thereof with other diisocyanates and polyisocyanates.

Crude MDI, in particular crude MDI having an NCO content of from 29 to 33% by weight and a viscosity at 25° C. in the range from 150 to 1000 mPas, has been found to be particularly useful as organic polyisocyanate.

Possible compounds having at least two hydrogen atoms which are reactive toward isocyanate groups which can be used in addition to the components bi) and bii) are ones which comprise at least two reactive groups, preferably OH groups, in particular polyether alcohols and/or polyester alcohols having OH numbers in the range from 25 to 800 mg KOH/g.

The polyester alcohols used are usually prepared by condensation of polyfunctional alcohols, preferably diols, having from 2 to 12 carbon atoms, preferably from 2 to 6 carbon atoms, with polyfunctional carboxylic acids having from 2 to 12 carbon atoms, for example succinic acid, glutaric acid, adipic acid, suberic acid, azelaic acid, sebacic acid, decanedicarboxylic acid, maleic acid, fumaric acid and preferably phthalic acid, isophthalic acid, terephthalic acid and the isomeric naphthalenedicarboxylic acids.

The polyesterols used usually have a functionality of 1.5-4.

In particular, use is made of polyether polyols prepared by known methods, for example by anionic polymerization of alkylene oxides onto H-functional starter substances in the presence of catalysts, preferably alkali metal hydroxides or double metal cyanide catalysts (DMC catalysts).

As alkylene oxides, use is usually made of ethylene oxide or propylene oxide, but also tetrahydrofuran, various butylene oxides, styrene oxide, preferably pure 1,2-propylene oxide. The alkylene oxides can be used individually, alternately in succession or as mixtures.

Starter substances used are, in particular, compounds having at least 2, preferably from 2 to 8, hydroxyl groups or at least 2 primary amino groups in the molecule.

As starter substances having at least 2, preferably from 2 to 8, hydroxyl groups in the molecule, preference is given to using trimethylolpropane, glycerol, pentaerythritol, sugar compounds such as glucose, sorbitol, mannitol and sucrose, polyhydric phenols, resols, e.g. oligomeric condensation products of phenol and formaldehyde, and Mannich condensates of phenols, formaldehyde and dialkanolamines and also melamine.

As starter substances having at least two primary amino groups in the molecule, preference is given to using aromatic diamines and/or polyamines, for example phenylenediamines and 4,4′-, 2,4′- and 2,2′-diaminodiphenylmethane, and also aliphatic diamines and polyamines such as ethylenediamine.

The polyether polyols have a functionality of preferably from 2 to 8 and hydroxyl numbers of preferably from 25 mg KOH/g to 800 mg KOH/g and in particular from 150 mg KOH/g to 570 mg KOH/g.

The compounds having at least two hydrogen atoms which are reactive toward isocyanate also include the chain extenders and crosslinkers which may be concomitantly used. To modify the mechanical properties, the addition of bifunctional chain extenders, trifunctional and higher-functional crosslinkers or, if appropriate, mixtures thereof can be found to be advantageous. As chain extenders and/or crosslinkers, preference is given to using alkanolamines and in particular diols and/or triols having molecular weights of less than 400, preferably from 60 to 300.

Chain extenders, crosslinkers or mixtures thereof are advantageously used in an amount of from 1 to 20% by weight, preferably from 2 to 5% by weight, based on the polyol component.

The production of the rigid foams is usually carried out in the presence of blowing agents, catalysts, flame retardants and cell stabilizers and, if necessary, further auxiliaries and/or additives.

As blowing agents, it is possible to use chemical blowing agents such as water and/or formic acid which react with isocyanate groups to eliminate carbon dioxide or carbon dioxide and carbon monoxide. Physical blowing agents can preferably also be used in combination with or in place of water. These are compounds which are inert toward the starting components and are usually liquid at room temperature and vaporize under the conditions of the urethane reaction. The boiling point of these compounds is preferably below 50° C. Physical blowing agents also include compounds which are gaseous at room temperature and are introduced into or dissolved in the starting components under superatmospheric pressure, for example carbon dioxide, low-boiling alkanes and fluoroalkanes.

The blowing agents are usually selected from the group consisting of formic acid, alkanes and/or cycloalkanes having at least 4 carbon atoms, dialkyl ethers, esters, ketones, acetals, fluoroalkanes having from 1 to 8 carbon atoms and tetraalkylsilanes having from 1 to 3 carbon atoms in the alkyl chain, in particular tetramethylsilane.

Examples which may be mentioned are propane, n-butane, isobutane and cyclobutane, n-pentane, isopentane and cyclopentane, cyclohexane, dimethyl ether, methyl ethyl ether, methyl butyl ether, methyl formate, acetone and also fluoroalkanes which can be degraded in the troposphere and therefore do not damage the ozone layer, e.g. trifluoromethane, difluoromethane, 1,3,3,3-pentafluoropropene, 1,1,1,3,3-pentafluorobutane, 1,1,1,3,3-pentafluoropropane, 1,1,1,2-tetrafluoroethane, difluoroethane and heptafluoropropane. The physical blowing agents mentioned can be used either alone or in any combinations with one another.

A particularly preferred blowing agent mixture is a mixture of formic acid, water and pentane.

The blowing agent component is usually used in an amount of from 1 to 45% by weight, preferably from 1 to 30% by weight, particularly preferably from 1.5 to 20% by weight and in particular from 2 to 15% by weight, based on the total weight of the components polyol, blowing agent, catalyst system and any foam stabilizers, flame retardants and other additives.

The polyurethane or polyisocyanurate foams usually comprise flame retardants.

Preference is given to using bromine-free flame retardants. Particular preference is given to using flame retardants comprising phosphorus atoms, in particular trischloroisopropyl phosphate, diethyl ethanephosphonate, triethyl phosphate and/or diphenyl cresyl phosphate.

Catalysts used are, in particular, compounds which strongly accelerate the reaction of the isocyanate groups with the groups which are reactive toward isocyanate groups.

Such catalysts are, for example, basic amines such as secondary aliphatic amines, imidazoles, amidines, alkanolamines, Lewis acids or metal-organic compounds, in particular those based on tin. Catalyst systems comprising a mixture of various catalysts can also be used.

If isocyanurate groups are to be incorporated into the rigid foam, specific catalysts are required. As isocyanurate catalysts, use is usually made of metal carboxylates, in particular potassium acetate and solutions thereof. The catalysts can, depending on requirements, be used either alone or in any mixtures with one another.

As auxiliaries and/or additives, use is made of the materials known per se for this purpose, for example surface-active substances, foam stabilizers, cell regulators, fillers, pigments, dyes, antioxidants, hydrolysis inhibitors, antistatic, fungistatic and bacteriostatic agents.

Further information about the starting materials, blowing agents, catalysts and auxiliaries and/or additives used for carrying out the process of the invention may be found, for example, in Kunststoffhandbuch, volume 7, “Polyurethane” Carl-Hanser-Verlag Munich, 1st edition, 1966, 2nd edition, 1983 and 3rd edition, 1993.

To produce the rigid foams based on isocyanate, the polyisocyanates and the compounds having at least two hydrogen atoms which are reactive toward isocyanate groups are reacted in such amounts that the isocyanate index in the case of the polyurethane foams is in the range from 100 to 220, preferably from 115 to 180.

To produce the rigid polyurethane foams, the polyisocyanates a) and the component b) are reacted in such amounts that the isocyanate index of the foam is from 90 to 350, preferably from 100 to 180, more preferably from 110 to 140.

The rigid polyurethane foams are obtained batchwise or continuously by means of known processes, for example on a double belt or in a mold.

It has been found to be particularly advantageous to employ the two-component process and combine the compounds having at least two hydrogen atoms which are reactive toward isocyanate groups with the blowing agents, foam stabilizers and flame retardants and also the catalysts and auxiliaries and/or additives to form a polyol component and react this with the polyisocyanates or the mixtures of the polyisocyanates and, if used, blowing agents, also referred to as isocyanate component.

The present invention is illustrated by the following examples.

| | Comp. | Comp. | Comp. | | | | | | | | | |
|---|---|---|---|---|---|---|---|---|---|---|---|---|
| | 1 | 2 | 3 | 1 | 2 | 3 | 4 | 5 | 6 | 7 | 8 | 9 |
| Polyol 1 | 30 | 30 | 30 | 30 | 30 | 30 | 30 | 30 | 30 | 30 | 30 | 30 |
| Polyol 2 | 48 | 30 | 48 | 30 | 30 | 30 | 30 | 30 | 38 | | 12 | 43 |
| Polyol 3 | 16 | 16 | | 16 | 16 | 16 | 16 | 16 | 16 | 16 | | |
| Polyol 4 | | 18 | | | | | | | | | | |
| Polyol 5 | | | | 18 | 18 | 18 | 18 | | 10 | | 36 | |
| Polyol 6 | | | | | | | | | | | | 5 |
| Polyol 7 | | | | | | | | 18 | | | | |
| Polyol 8 | | | | | | | | | | 48 | | |
| Polyol 9 | | | 16 | | | | | | | | 16 | |
| Silicone stabilizer | 1.9 | 1.9 | 1.9 | 1.9 | 1.9 | 1.9 | 1.9 | 1.9 | 1.9 | 1.9 | 1.9 | 1.9 |
| Catalyst | 1.9 | 1.9 | 1.9 | 1.9 | 1.9 | 1.9 | 1.9 | 1.7 | 1.9 | 1.9 | 1.9 | 1.9 |
| Water | 2.3 | 2.3 | 2.3 | 2.3 | 2.3 | 2.3 | 2.3 | 2.3 | 2.3 | 2.3 | 2.3 | 2.3 |
| Cyclopentene 95% | 13 | 13 | 13 | 13 | 13 | 12 | | 13 | 13 | 13 | 13 | 13 |
| Isopentane | | | | | | | | | | | | |
| Isobutane | | | | | 2 | | | | | | | |
| Perfluorohexane | | | | | | 2 | | | | | | |
| 245 fa | | | | | | | 35 | | | | | |
| Viscosity of polyol | 8000 | 4000 | 15000 | 6500 | 6500 | 6500 | 6500 | 6000 | 7000 | 9500 | 9000 | 8500 |
| component, 25° C. [mPas] | | | | | | | | | | | | |
| Mixing ratio A:B | 126 | 126 | 140 | 126 | 125 | 125 | 105 | 126 | 126 | 126 | 140 | 152 |
| Binding time [s] | 38 | 35 | 40 | 38 | 41 | 37 | 38 | 39 | 42 | 38 | 37 | 36 |
| Demolding thickness at 15% | 94.8 | 96.2 | 93.0 | 94.0 | 94.1 | 93.9 | 93.8 | 93.8 | 94.3 | 94.1 | 92.7 | 94.2 |
| overfilling 3 min. [mm] | | | | | | | | | | | | |
| Thermal conductivity [mW/mK] | 19.0 | 19.7 | 18.7 | 19.1 | 19.3 | 18.2 | 17.8 | 18.9 | 19.1 | 19.2 | 18.9 | 18.8 |
| Flow factor | 1.34 | 1.30 | 1.31 | 1.33 | 1.30 | 1.32 | 1.30 | 1.33 | 1.32 | 1.34 | 1.33 | 1.32 |
| Compressive strength [N/cm²] | 15.7 | 15.6 | 16.0 | 15.9 | 16.1 | 15.9 | 15.6 | 15.6 | 15.8 | 16.0 | 16.2 | 15.9 |

Polyol 1: polyether alcohol based on vicinal TDA, ethylene oxide and propylene oxide, hydroxyl number: 390 mg KOH/g
Polyol 2: polyether alcohol based on sucrose, glycerol and propylene oxide, functionality 5, hydroxyl number: 450 mg KOH/g
Polyol 3: polyether alcohol based on vicinal TDA, ethylene oxide and propylene oxide, hydroxyl number: 160 mg KOH/g
Polyol 4: polyether alcohol based on oligomeric glycerol and propylene oxide, functionality 4.5, hydroxyl number: 450 mg KOH/g
Polyol 5: polyether alcohol based on oligomeric glycerol and propylene oxide, functionality 6.5, hydroxyl number: 450 mg KOH/g
Polyol 6: polyether alcohol based on oligomeric glycerol, functionality 6.5, hydroxyl number: 1100 mg KOH/g
Polyol 7: polyether alcohol based on sucrose, glycerol, ethylene oxide and propylene oxide, functionality 6.5, hydroxyl number: 450 mg KOH/g
Polyol 8: polyether alcohol based on sucrose, glycerol, oligomeric glycerol and propylene oxide, functionality 6, hydroxyl number: 450 mg KOH/g
Polyol 9: polyether alcohol based on vicinal TDA, ethylene oxide and propylene oxide, hydroxyl number: 160 mg KOH/g and comprising 35% of grafted acrylonitrile/styrene (3:1) particles.
Silicone stabilizer: Tegostab ® B 8462 Degussa,
Catalyst: mixture of 26% of N,N-dimethylcyclohexyamine, 53% of Lupragen ® N301, BASF SE, 21% Lupragen ® N600, BASF SE.

1. A process for producing a rigid polyurethane foam, the process comprising reacting
a) at least one polyisocyanate with
b) compounds having at least two hydrogen atoms which are reactive toward isocyanate groups in the presence of
c) at least one blowing agent,
wherein the compounds b) comprise:
at least one polyether alcohol bi) prepared by addition of at least one alkylene oxide onto toluenediamine; and
at least one polyether alcohol bii) prepared by addition of at least one alkylene oxide onto at least one H-functional starter substance comprising oligomeric glycerol.

2. The process of claim 1, wherein the oligomeric glycerol comprises 4-10 glycerol units.

3. The process of claim 1, wherein the polyether alcohol bii) has a hydroxyl number in a range from 350 to 500 mg KOH/g.

4. The process of claim 1, wherein the starter substance in preparing the polyether alcohol bii) comprises exclusively oligomeric glycerol.

5. The process of claim 1, wherein the starter substance in preparing the polyether alcohol bii) comprises oligomeric glycerol and at least one further H-functional compound.

6. The process of claim 1, wherein the starter substance in preparing the polyether alcohol bii) comprises oligomeric glycerol and sucrose.

7. The process of claim 1, wherein the starter substance in preparing the polyether alcohol bii) comprises oligomeric glycerol and at least trimethylolpropane.

8. The process of claim 6, wherein the polyether alcohol bii) has a molar ratio of oligomeric glycerol to sucrose of from 2.5:1 to 1:2.5.

9. The process of claim 1, wherein at least one selected from the group consisting of 2,4-toluenediamine and 2,6-toluenediamine is employed in preparing the polyether alcohol bi).

10. The process of claim 1, wherein vicinal toluenediamine is employed in preparing the polyether alcohol bi).

11. The process of claim 1, wherein at least 25% by weight, based on a weight of the toluenediamine, of vicinal toluenediamine is employed in preparing the polyether alcohol bi).

12. The process of claim 1, wherein at least 95% by weight, based on the weight of the toluenediamine, of vicinal toluenediamine is employed in preparing the polyether alcohol bi).

13. The process of claim 1, wherein the polyether alcohol bi) has a hydroxyl number in a range from 120 to 450.

14. The process of claim 1, wherein the components bi) and bii) are employed in a weight ratio of from 5:1 to 1:2.

15. The process of claim 6, wherein the polyether alcohol bii) has a molar ratio of oligomeric glycerol to sucrose of from 2.5:1 to 1:2.5.

16. The process of claim 1, wherein the compounds b) further comprise:
a polyether alcohol biii) initiated with at least sucrose.

17. The process of claim 16, wherein the polyether alcohol biii) has a hydroxyl number in a range from 350 to 550.

18. The process of claim 16, wherein the polyether alcohols bii) and biii) are employed in a weight ratio of from 1:10 to 2:1.

19. A rigid polyurethane foam, prepared by the process of claim 1.

20. The process of claim 1, wherein the starter substance in preparing the polyether alcohol bii) consists essentially of oligomeric glycerol.
